(19) United States
(12) Patent Application Publication
(10) Pub. No.: US 2005/0177510 A1
(43) Pub. Date: Aug. 11, 2005

(54) Buyer initiated payment

(75) Inventors: Nathan John Hilt, San Mateo, CA (US); William Alexander Thaw, South San Francisco, CA (US); Laura Suzanne Cuda, San Francisco, CA (US)

Correspondence Address: BEYER WEAVER & THOMAS LLP, P.O. BOX 70250, OAKLAND, CA, 94612-0250, US

(73) Assignee: Visa International Service Association, A Delaware Corporation, Foster City, CA (US)

(21) Appl. No.: 11/055,670

(22) Filed: Feb. 8, 2005

Related U.S. Application Data
(60) Provisional application No. 60/543,033, filed on Feb. 9, 2004.

(51) Int. Cl. G06F 17/60

(52) U.S. Cl. 705/40; 705/42

(57) ABSTRACT

Transferring funds from a payment originator (or payor) to a payment beneficiary (or payee) pushes the funds directly to a beneficiary's bank. The beneficiary's bank is not required to actively pull funds into the beneficiary's account. An originator can use a publicly known beneficiary indicator to direct payment to the beneficiary. The publicly known beneficiary indicator can be publicly used without exposing a beneficiary account to unauthorized debits or fraud since it can only be used to make credits to the beneficiary account, e.g. a deposit-only account. A pre-settlement conversation is used between the two banks to verify and evaluate information about an upcoming transfer of funds to determine whether to accept the funds transfer. The messages in the pre-settlement conversation contain information about the transaction.

### CROSS-REFERENCE TO RELATED APPLICATIONS

This application claims priority of U.S. Provisional patent application No. 60/543,033, filed Feb. 9, 2004, entitled “Buyer Initiated Payment,” which is hereby incorporated by reference.

### FIELD OF THE INVENTION

The present invention relates generally to funds transfer techniques, and more specifically to funds transfer techniques that push funds to a beneficiary.

### BACKGROUND

When a person makes a payment to another person, organization, or corporation, he or she may use cash or other types of payment instrument such as checks, credit cards, debit cards, smart cards, gift cards, ACH (Automated Clearing House) transactions, and “direct debit” domestic payment schemes. Such payments can be for purposes such as bill payment, purchases of goods or services, or for the transfer of funds. Terms such as payment originator, buyer, purchaser, payor, consumer, customer, and the like can describe the entity that wishes to make a payment. Terms such as payment beneficiary, seller, merchant, payee, and the like can describe parties that wish to receive a payment.

Most of the conventional payment techniques listed above can be viewed as “pull” payment methodologies; in other words, the payee must “pull” payment from the payor's financial institution using information obtained via the payment instrument. Pulling a payment amount involves an active step taken by the payee to request funds from an institution that maintains an account of the payor.

For example, a payor may wish to use a credit card when buying an item from a merchant or when apprised of a bill that is due. The payor then provides the payee with the payor's credit card number and authorization to charge the amount due. So far the payee has the credit card information but has not in fact received any funds. Next, the payee must run the transaction (basically the credit card number and the amount) through a clearing and settlement system in order to actually “pull” the funds from the payor's bank and have the funds moved to a bank account of the payee. When a payor uses a prepaid card (such as a “gift” card or other prepaid product) the result is the same, the payee must take action in order to move the funds into its own account.

In another scenario, a payor can write a physical check to the payee or in some circumstances the payor can provide only the routing and checking account number to the payee. However, at that point in time, the amount due the payee has yet to be transferred. The payee must then process the check through its bank, which uses the check routing number, the checking account number and the amount with which to approach the payor's bank and demand payment. Assuming there are sufficient funds, the payor's bank then transfers the amount due from the payor's bank to the payee's bank—again the payee must pull the funds. In those circumstances where the payor uses a debit card to pay from their own checking account, the result is the same in that the payee (or its bank) must take action in order to move the funds from the payor's checking account into its own account.

In yet another scenario, a payor can provide information to a payee such that the payee can pull funds from an account via an ATM Network. Usually an ATM Network requires a debit card number and a Personal Identification Number (PIN) to authenticate and route payments. Similar to other pull scenarios, the payee has to perform specific functions to present the appropriate information to the ATM Network and then the Network will initiate a message that effectively moves funds from the payor's ATM account to the payees' account.

An ACH transaction usually requires funds to be pulled. A typical ACH transaction involves a payor who provides their routing and transit number that is then used by the payee to pull funds from the payor account into their own account.

The payment techniques described above have become widely used, however they have the common drawback that the payee is required to pull funds from the payor's financial institution. The “pull” model lends itself to many markets and products, yet has inherent drawbacks and risks, requires a high level of guarantees among participants, and requires a costly infrastructure supported by participants. Unfortunately, the pulling process imposes extra process steps upon a payee, including the need for the payee to authenticate the payor, which requires expensive equipment and/or a real time authorization system

Although the above “pull” payment methodologies have worked well for some time, there are continuing efforts to provide improved and simplified payment techniques.

### BRIEF SUMMARY OF THE INVENTION

The present invention pertains to techniques for transferring funds from a payment originator (“originator”) to a payment beneficiary (“beneficiary”) by pushing the funds directly from an originator bank (“Bank O”) to a beneficiary bank (“Bank B”). One embodiment of the present invention allows the originator to push payment directly to a beneficiary's financial institution without needing to set up a prior relationship or register for the service. The payment may be a one-time, ad-hoc payment where no prior relationship exists between an originator and a beneficiary. The payment may also be part of an ongoing series of payments where there is an established relationship between an originator and a beneficiary.

In another embodiment, the banks of the originator and beneficiary engage in a pre-settlement conversation to firm up details of the transaction before funds are actually moved from the originator to the beneficiary. This conversation helps to avoid errors and ensures smooth settlement. A prior art technique used by the Automated Clearing House Network (ACH) uses a “pre-note” operation but is usually not a conversation between banks. Typically this is a one-way stream of data. The pre-settlement conversation between the originator and the beneficiary bank is a two-way exchange of information in which details such as time of posting, account numbers and amounts are verified.

In another embodiment, the present invention utilizes a deposit-only account number for a beneficiary into which funds pushed from an originator are deposited. One advantage is that such a deposit-only account number can be freely distributed by a beneficiary without fear that an unscrupulous party might be able to withdraw funds from the account once the account number is known. Because it is a deposit-only account number, no one can use that number to withdraw funds from the account using the publicly available information.

As a method, one embodiment of the present invention includes at least sending a payment message by an originator to an originator bank (the payment message requesting the originator bank to push a monetary amount to a beneficiary bank), indicating a beneficiary indicator in the payment message (the public beneficiary indicator indicating a beneficiary account that will be credited with the monetary amount), and pushing the monetary amount from the originator bank to the beneficiary bank wherein the beneficiary account is credited with the monetary amount.

In an alternative embodiment of the method, the invention includes at least sending a funds verification message from an originator bank to a beneficiary bank (the funds verification message informing the beneficiary bank of the monetary amount to be transferred to the beneficiary bank), sending a funds verification response message to the originator bank (the funds verification response message serving to approve or decline the transfer of the monetary amount), and pushing the monetary amount into a beneficiary account maintained by the beneficiary bank if the funds verification response message approves the transfer.

As a system, one embodiment of the present invention includes at least an originator, a beneficiary, an originator bank that maintains an originator account, a beneficiary bank identified by a bank identification number, that maintains a beneficiary account and a beneficiary indicator, a funds verification message that is sent from the originator bank to the beneficiary bank (the funds verification message informing the beneficiary bank of the monetary amount to be transferred to the beneficiary bank), and a funds verification response message that is sent to the originator bank (the funds verification response message serving to authorize or decline the transfer of the monetary amount).

These and other features and advantages of the present invention will be presented in more detail in the following specification of the invention and the accompanying figures, which illustrate by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 illustrates a “push” payment system suitable for implementing a push payment transaction according to one embodiment of the present invention.

FIG. 2 illustrates a diagrammatic view of a payment participant reference file (PPRF) according to one embodiment of the present invention.

FIGS. 3A-3C illustrate a flow diagram that describes the push payment process and the reversal and sendback options according to one embodiment of the present invention.

FIG. 4 is a decision tree showing an embodiment for reversals and sendbacks.

FIG. 5 is a block diagram showing an embodiment for cross-border remittance.

FIG. 6 is a block diagram showing an embodiment for consumer bill payment.

FIG. 7 is a block diagram showing an embodiment for topping up a mobile telephone.

FIG. 8 is a block diagram showing an embodiment for a person-to-person payment.

FIGS. 9 and 10 illustrate a computer system suitable for implementing embodiments of the present invention.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known operations have not been described in detail so not to unnecessarily obscure the present invention.

The present invention pertains to techniques for transferring funds from a payment originator (“originator”) to a payment beneficiary (“beneficiary”) by pushing the funds from an originator bank (“Bank O”) directly to a beneficiary bank (“Bank B”). The transfer of funds can be for various purposes such as bill payment, payment for purchases of goods or services, and sending funds between parties. Since the funds transfer techniques involve pushing of the funds by Bank O, Bank B is not required to actively pull funds from the originator account into the beneficiary's bank account.

An originator can use a publicly known beneficiary indicator to direct payment to the beneficiary or a beneficiary indicator that is linked to an already existing account access device such as a credit or debit card or any other recognized indicator that Bank B can use to identify the correct and valid beneficiary account. The publicly known beneficiary indicator can be publicly used without exposing a beneficiary account to unauthorized debits or fraud since it can only be used to make credits to the beneficiary account. In such cases, the beneficiary indicator can be referred to as a deposit-only number.

In some embodiments, two-way messages are used to hold a pre-settlement conversation in which one entity provides information about an upcoming transfer of funds and the other entity reviews such information to determine whether to accept the funds transfer. This conversation allows for confirmation of details regarding the transaction, which lowers the chances of transfer errors, and gives Bank B an opportunity to review the transaction for legal and regulatory compliance. The transfer of funds can be for domestic or international transactions. The transfers can also occur online, offline, in real time, or in batched processes.

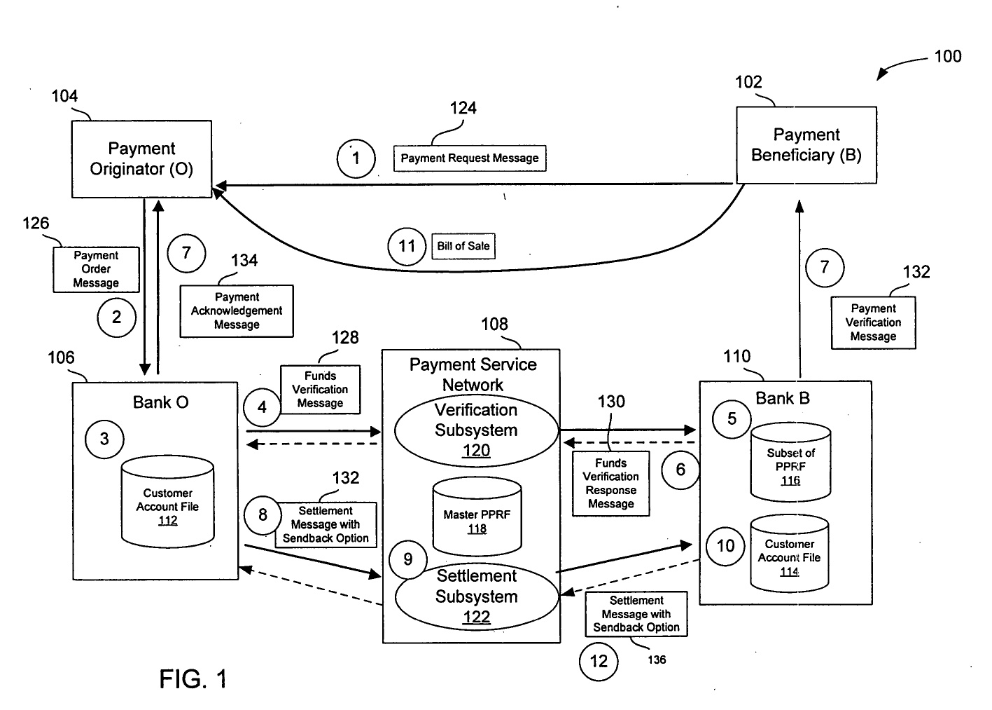

The funds transfer technique of the present invention can be used in many scenarios whether an originator and beneficiary are dealing with each other in a face-to-face, online, or offline situation. In each case, the beneficiary indicator is made known to the originator, in one or more various manners, so that funds are accurately pushed to the beneficiary, to pay a bill, for example. For example, the beneficiary indicator can be listed in a bill or invoice, posted on the Internet, listed in any publication, verbally communicated, or sent via electronic mail or a text message service. A bill can include the following information: amount due, due date, beneficiary indicator, a customer account at the biller to be credited, and various types of originator account details. A bill is represented by the payment request message 124, which will be discussed below with respect to FIG. 1. To make a payment using the technique of the present invention, the customer would contact their bank or an agent of the bank with the above information, the bank could authenticate the identity of the customer, the bank then pushes funds to the biller's financial institution, and then the biller's bank then passes the remittance information to the biller.

In one bill payment scenario, a franchisee can make payments to a franchiser by pushing funds to the franchiser.

In another example, a merchant who sells a product or service can provide a customer in a person-to-person or an online scenario with the beneficiary indicator so that the customer can pay for the product or service. In such a transaction, the merchant can provide the customer with information such as: amount due, transaction date, and the merchant's beneficiary indicator. In a person-to-person scenario, a customer can use devices such as mobile phones and automated teller machines (ATM's) to utilize the beneficiary indicator to push funds to the beneficiary. One such person-to-person transaction can occur, for example, at a flea market. The customer can contact his or her bank and provide the information received from the merchant. The customer's bank would then authenticate the identity of the customer. The customer's bank would then push a payment amount to the merchant or the merchant's bank based upon the information provided by the customer. The merchant's bank then receives the payment and then sends a confirmation message to the merchant. The merchant can use various devices such as a mobile telephone to receive a payment verification message, which informs the merchant that funds has been credited to his or her account. The payment verification message can include information such as: transaction amount, transaction date, transaction tracking number, account number from which payment was sent. Once payment is received by the merchant's bank, the merchant's account is credited.

In another scenario, an online merchant can sell digital content, such as a music file, by attaching the beneficiary indicator to the content. The customer can then access the content by using the beneficiary indicator to push the purchase amount to the merchant. Then in exchange, the beneficiary can provide access to the enhanced content, for example, by providing a key or password to the customer.

In yet another scenario, a customer can add value to an account held with a service provider, such as a mobile phone service provider. Such an account allows the customer to take advantage of the service, that is, to make mobile telephone calls. The customer can “top up” his or her account by using the beneficiary indicator to push funds into their account. A beneficiary can optionally send a request for a customer (the originator) to top up his or her account.

In each of these use scenarios, funds are transferred directly into a beneficiary's account without the need for the beneficiary to take an active step of pulling funds from the originator's account. For example, the beneficiary need not present a customer's credit card number or a check received from the originator to Bank O in order to request the funds related to the transaction. Instead, funds will be automatically pushed into the beneficiary's account via their own beneficiary indicator, which simplifies the payment process for the beneficiary. Beneficiaries who are able to receive funds pushed by an originator gain another avenue for receiving electronic payments. The technique of the present invention is easily implemented since no special devices are necessary for implementation. For instance, special card reading devices are not necessary. This is especially advantageous for low-volume merchants who have a more difficult time bearing the costs of such special devices. Actually, the funds transfer technique of the present invention also benefits other parties, such as beneficiary banks and payment originators. The beneficiary banks are better able to serve such low-volume merchants and the payment originators are given another electronic payment option.

Electronic bill payment provides a good illustration of how a buyer initiated payment capability can be used by payment service providers, such as Visa and it's member banks, to fill the needs of low-volume merchants and complement existing payment techniques. Within the electronic bill payment/recurring payment market, Visa is making good progress driving acceptance among selected categories of merchants. Having said that, many Visa Members that issue debit cards are very interested in capturing these forms of payments through their direct service channels, such as PC based home banking, phone banking and ATM's. Visa does not have a means for its member banks to process these transactions through VisaNet to the merchant. As a result, Members process these transactions through services that do not generate any revenue to the Issuer.

As electronic bill payment becomes more popular and member banks become more successful at consolidating those payments through their service infrastructure, service providers without a buyer initiated payment will miss an opportunity to help improve member bank profitability. The basic challenge member banks have in operating these services is that they do not generate a discrete stream of revenue, while they do deliver a significant benefit to the biller in reduced remittance processing and collection costs.

By creating a buyer initiated payment transaction, a payment service provider could fill an important need for member banks that envision certain types of payment being delivered directly through their service infrastructure.

### Push Payment System

FIG. 1 illustrates a “push” payment system 100 suitable for implementing a push payment transaction according to one embodiment of the present invention. FIG. 1 illustrates the components that form push payment system 100 and directional lines that describe an exemplary process flow for the push payment process. Each process of the push payment process is labeled with a number that is placed within a circle. For instance, step 1 is represented in FIG. 1 by the encircled numeral 1 that is placed next to the directional line.

Using this system, an entity owing funds can push funds and related data to an entity that is owed funds. Payment can be a one-time ad hoc payment, or a payment may be one of a series of payments that are part of an ongoing, pre-established relationship between the two parties. As will be described below, this embodiment of the invention involves a pre-settlement conversation between banks to confirm details regarding the transaction in order to minimize occurrences of transaction errors and to provide an opportunity to ensure that transactions are in legal and regulatory compliance.

Push payment system 100 includes a payment beneficiary 102, a payment originator 104, an originator bank 106, a payment service network 108, and a beneficiary bank 110. Payment originator 104 is any person or entity required to or desiring to make a payment or transfer of funds. Originator 104 can initiate payment from any account they hold with Bank O. For example, an originator 104 can be a customer desiring to purchase a good or service online or in-person, an account holder who needs to pay a bill, or any person desiring to send funds to another person or entity.

Payment beneficiary 102 is any person or entity destined to receive the funds pushed by originator 104. For example, beneficiary 102 can be a merchant who is selling a good or service, a service provider who requires payment of a bill, or a person who will receive funds (for example, a college student who will receive funds from his or her parents). Beneficiary 102 has a beneficiary indicator that uniquely identifies them within push payment system 100 or to Bank B 110. Again, one type of beneficiary indicator can be made publicly known and can be used to only post credits to the beneficiary's bank account.

Originator bank (“Bank O”) 106 is any financial institution having any sort of account relationship with originator 104. Included within Bank O 106 is a customer account file 112, which is any suitable financial database holding customer account information. In particular, customer account file 112 includes a current balance entry for an account of originator 104. Customer account file 112 can be used by Bank O 106 to authenticate an originator's account. For example, customer account file 112 can be used to verify payment originator 104 has an account with Bank O 106 and that the account is valid. Bank O 106 offers originators 104 the ability to “push” payment to beneficiaries 102 since the bank in which they have a relationship, Bank B 110 is registered with the payment service network 108. Funds from Bank O 106 can come from a variety of sources and accounts, such as cash, checking, savings, credit, and prepaid accounts.

Beneficiary bank (“Bank B”) 110 is any suitable financial institution having an account relationship with beneficiary 102. Bank B 110 also includes a customer account file 114 that holds account information such as that for beneficiary 102. Customer account file 114 is also used by Bank B 110 to authenticate a beneficiary's account. For example, customer account file 114 can be used to verify that beneficiary 102 has an account with Bank B 110 and that the account is valid. Bank B 110 also includes a database 116, which contains a subset of a master payment participant reference file (PPRF) 118 that is maintained by payment service network 108. PPRF 118 is explained in more detail below. Bank B 110 is any bank that offer beneficiaries 102 the ability to receive payment through the push payment process of the present invention because Bank B 110 is registered with payment service network 108.

Note that Bank O 106 and Bank B 110 can be any type of institution that handles an account funded by originator 104 and beneficiary 102. Bank O 106 and Bank B 110 do not necessarily have to be banks. For example, Bank O 106 or Bank B 110 could be a mutual fund institution, credit union, stock broker, investment manager, postal bank, agents of banks, funds transfer facilitators, basically any type of deposit taking or receiving institution.

Also note that originator 104 can also receive pushed amounts of funds just like beneficiary 102 and beneficiary 102 can also push funds to originator 104. Originators 104 and beneficiaries 102 are limited in their respective roles, yet they can assume the role of either an originator or beneficiary according the specific situation. However, for purposes of explaining the push payment process of the present invention in a clear and simple manner, originator 104 and beneficiary 102 are described in this specification only with respect to their roles as originators and beneficiaries.

Payment service network 108 is a suitable network able to process and deliver financial messages between financial institutions. Banks O and B are both connected to payment service network 108. Payment service network 108 is able to process both pin-based transactions and non-pin-based transactions. In one embodiment, payment service network 108 has global switch functionality. Payment service network 108 has numerous functions, one of which is to create and standardize messaging formats for various messages to be transmitted between Bank O 106 and Bank B 110 to conduct a pre-settlement conversation and the settlement process as well as all related reconciliation messages such as reversals and sendbacks.

Payment service network 108 also has an obligation to regulate the use of the standardized messages, reconciliation messages, such as when they can appropriately be used, for which reasons and in what time frames, such that participants in the network are assured of consistency and fairness.

Payment service network 108 is also responsible for creating and maintaining PPRF 118. The master payment participant reference file (“PPRF”) 118 is a master database of all banks that participate in payment service network 108 and that are able to use push payment system 100. In one embodiment, PPRF 118 is a relational database. The PPRF 118 is used to maintain exclusivity, tracking, processing and routing of payments between participants in payments service network 108. The PPRF 118 can be duplicated or subdivided and distributed to participants such that participants are informed and can create subsets (PPRF 116) specific to their needs and interests. Entities identified in the PPRF can be subdivided such that banks can identify unique customers and assign beneficiary indicators as needed. Menus and tables control functionality for banks and their customers within the PPRF 118.

PPRF 118 can also include a number of participant indicators that provide for a greater specificity of information about customers for the bank participants. Those additional participant indicators can be configured in a variety of formats and lengths and are carried in messages 128 and 132 to provide greater detail to Bank B 110 for describing and identifying beneficiary 102.

In some embodiments, each bank participant is given one or multiple bank identification numbers that allows each bank to be uniquely identified within the payment service network 108. Being uniquely identified allows banks to process transactions through the payment service network 108 and to conduct business to meet their customer's needs.

The PPRF 118 works with edits contained in the payment service network 108 such that a bank can utilize certain services and disable others.

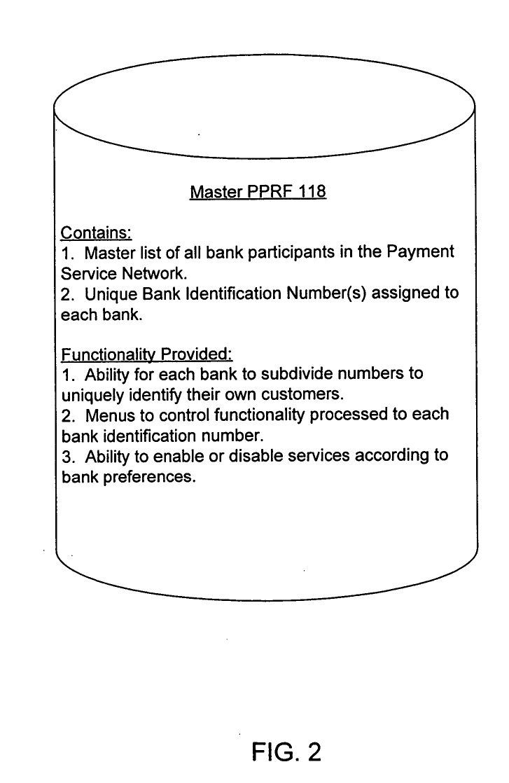

FIG. 2 illustrates a diagrammatic view of PPRF 118 according to one embodiment of the present invention. FIG. 2 illustrates the contents contained within PPRF 118 and the functionality provided by the PPRF 118.

Also included in the payment service network is an online verification subsystem 120 which processes real-time messages to and from banks connected to the payment service network 108 and a settlement subsystem 122 which processes batch settlement transactions, performs multi-currency conversion and settles funds to banks connected to the payment service network 108.

### Push Payment Methodology

One implementation of the present invention begins with registration. Beneficiary 102 and originator 104 need not have any previous relationship with each other in order for originator 104 to push funds to beneficiary 102. This is because the funds pushing capability is provided through the respective banks of beneficiary 102 and originator 104, which have previously registered with a payment service network 108 that facilitates the funds pushing technique. The beneficiary 102 and originator 104 employ the services of their respective banks in order to transfer funds through the push payment process. After communicating with their banks, a beneficiary indicator is assigned to the beneficiary 102 (and then eventually provided to the originator) that allows the originator 104 to identify the beneficiary 102 as the party to whom funds should be transferred. So long as the originator 104, beneficiary 102, and their respective banks have shared the proper identification information and relevant data, an originator 104 can push a payment to beneficiary 102 with or without any previously established relationship. An originator 104 can push a monetary amount to a beneficiary 102 by supplying a beneficiary indicator. An originator 104 may also supply other information, such as but not limited to, the amount of funds to be pushed, secondary account identifiers, and relevant payment information. This allows, for example, an originator 104 to encounter a beneficiary 102 for the first time and immediately push funds to the beneficiary 102 by simply utilizing a beneficiary indicator. Likewise, beneficiary 102 might not be aware that he or she will receive funds from originator 104 until originator 104 or Bank O 106 indicates that funds will be pushed to beneficiary 102.

Originators 104 and beneficiaries 102 can obtain a beneficiary indicator by registering with their respective banks to use the push payment process. Their banks are presumed to have already registered with payment service network 108. Bank O 106 and Bank B 110 then work together with payment service network 108 to assign beneficiary indicators to beneficiaries 102. Bank O 106 and Bank B 110 can use their own respective processes for registering originators 104 and beneficiaries 102. According to the invention, originators 104 and beneficiaries 102 need not utilize services from or register with a third party payment service. Pre-existing services require each of an originator 104 and a beneficiary 102 to register with the same third party payment service. Instead, the push payment process of the present invention only requires that each beneficiary 102 and originator 104 register with their own banks respectively.

After the participants have been properly identified and relevant data has been shared, funds can be pushed by an originator 104 through push payment system 100. The push payment process is initiated when an originator 104 desires to send funds to a beneficiary 102. This occurs in various situations, such as when originator 104 purchases a product from beneficiary 102, needs to pay a bill due to beneficiary 102, or desires to send funds to beneficiary 102. In one situation, a payment request message 124 is sent from beneficiary 102 to originator 104 in step 1. Payment request message 124 may be formal or informal, may take the form of a sales contract or an invoice, may be written or oral, or may be transmitted electronically. Payment request message 124 can include information such as an amount due, a due date, the type of currency to tender, a beneficiary indicator that indicates an account of beneficiary 102, date and time, and a trace number or transaction identifier.

In another situation, beneficiary 102 does not send a payment request message. Rather, originator 104 initiates a push payment without a prompt from beneficiary 102. This is the case, for example, when the originator 104 desires to transfer funds to a beneficiary such as for a gift or when originator 104 desires to “top up’ a prepaid account maintained for using a service such as a mobile phone. In these cases, originator 104 locates or has previously been informed of the beneficiary indicator.

Again, the beneficiary indicator can be a publicly available number, especially when it can only be used to send credit messages to Bank B 110. A beneficiary indicator, such as a deposit-only number, may be assigned to each beneficiary 102 by payment service network 108 or Bank B 110. A deposit-only number is then used to route only credit messages to Bank B 110. The deposit-only number is a combination of a routing number, which indicates Bank B 110 and the beneficiary account, as identified by Bank B 110. A deposit-only number cannot be used to route debit messages to an account at Bank B 110. Payment service network 108 monitors all types of transactions, including purchases, cash withdrawals, and various types of credits and deposits. Payment service network 108 also controls the flow of messages such that only credits and deposits are accepted. Other transaction types, such as, cash withdrawals and purchase transactions will be systematically declined. In this way, the deposit-only number can be made publicly known without any danger that unauthorized withdrawals will be made from a beneficiary's account.

One embodiment of the invention uses a particular numbering scheme for the deposit-only account numbers and this numbering scheme is enforced not only by the payment service network 108 and its databases, but also by all participants in the system. By having such a global and systemic numbering scheme that is enforced by all participants, the robustness of a deposit-only account and its benefits are ensured.

In an alternative embodiment, beneficiary indicator can be a name that references beneficiary 102. For example, a beneficiary indicator for “Sam's Hardware Store” could be “Sam's Hardware.” An originator 104 would then use “Sam's Hardware” to identify the beneficiary to whom funds should be push. A name-to-account number conversion table for correlating the beneficiary indicator to the account into which funds is to be pushed is used to direct the pushed funds. Bank B 110 may maintain such a name-to-account number conversion table, for instance, in the subset of PPRF 116. In the same manner, the beneficiary indicator could also be a unique number that correlates to an account of beneficiary 102. This number could be made known to originator 104 or to the public at large, then a conversion table would then again be used by Bank B 110 to direct the pushed funds. In all cases, the beneficiary indicator can be a series of numbers, letters, or a combination of both.

Some embodiments of the present invention use both a bank identification number and a bank beneficiary indicator. The bank beneficiary indicator may or may not be assigned by the payment service network. One advantage in using a bank beneficiary indicator is that a beneficiary bank does not have to assign an additional indicator for a customer that the beneficiary bank may already recognize and process transactions to. This will minimize the impacts to beneficiary banks and allow for greater utility of the payment service network by enabling alternative beneficiary indicators to be processed in the messages between the banks.

Once originator 104 receives payment request message 124, originator 104 generates a payment order message 126 that is delivered to Bank O 106 in step 2. Payment order message 126 may take any suitable form and includes data from payment request message 124. Payment order message 126 includes at least the beneficiary indicator and the amount to push to beneficiary 102. Payment order message 126 may also include a field to indicate whether the transaction is for bill payment, a purchase transaction, or for funds transfer, an invoice number, customer reference number, etc.

Originator 104 can send payment order message 126 through various manners such as through a computer, a telephone, ATM, by going to Bank O 106, a cell phone, through the Internet, personal digital assistant, or a kiosk, etc., or by going to or accessing an agent of Bank O 106. Telephonic techniques include interactive voice response, live customer service, and proprietary mobile services. In a person-to-person transaction, for example, at a flea market, beneficiary 102 and originator 104 can utilize the system with their mobile phones. That is, originator 104 can send a payment order message 126 that includes an amount and a beneficiary indicator by using his or her mobile phone. Each of originator 104 and beneficiary 106 can also receive messages from their respective banks that notify them regarding the status of the transaction.

Step 3, Bank O 106 authenticates payment order message 126 and the identity of originator 104. Such authentication prevents imposters from transferring funds from the originator's account. Various authentication processes can be used, such as with the use of an ID and secret password. Bank O 106 also verifies that sufficient funds are present in originator's account prior to any transaction with the payment service network 108 is initiated. Having sufficient funds can be referred to as having “good funds.” These processes can be accomplished by accessing the customer account file 112.

After the authentication process is completed, Bank O 106 secures the funds from an account of originator 104. For example, funds can be secured within a demand deposit account, a funds market account, or in a credit line account. The authentication process allows Bank O 106 to verify information about the requested transaction before primary interaction with the payment service network 108 and Bank B 110. This advantageously allows Bank O 106 to avoid errors, discrepancies, and/or fraud early in the payment process and does not require the payment service network to facilitate large numbers of inter-bank dispute resolution and reconciliation efforts.

At step 4, Bank O 106 and Bank B 110 begin a pre-settlement conversation where each bank is able to confirm the details regarding the push payment transaction. The pre-settlement conversation includes messages sent by each bank to the other bank through payment service network 108 where the messages contain detailed information about the push payment transaction. The pre-settlement conversation allows both Bank O 106 and Bank B 110 to obtain useful and relevant information before funds are entered into settlement. As a result, exception items should be low, a better service will be available to originator 104, the number of payment reversals should be minimized, and fewer disputes regarding payments should arise.

The pre-settlement conversation allows the transaction participants to validate the accuracy of data relating to the push transaction, ensure the payment data can be accepted, notify Bank B 110 of the proposed transaction, and review the transaction for regulatory compliance.

The pre-settlement conversation is initiated through funds verification message 128 and funds verification response message 130. Funds verification message 128 is sent in step 4 from Bank O 106 to Bank B 110 through payment service network 108. Fund verification message 128 is sent through verification subsystem 120, which relays the message to Bank B 110. Payment service network 108 reviews master PPRF 118 to determine if Bank B 110 is registered to support the transaction.

Funds verification message 128 includes information about the push payment transaction. In step 5, Bank B 110 evaluates the information contained within funds verification message 128 for accuracy and for regulatory and legal compliance. Based upon the evaluation by Bank B 110, funds verification response message 130 will indicate if Bank B 110 will accept or decline the push payment settlement message.

Funds verification message 128 includes information about the push payment transaction such as the beneficiary indicator, the amount to push to beneficiary 102, an indicator as to if the transaction is for bill payment, a purchase transaction, or for funds transfer, etc., an invoice number, posting technique and timing, account numbers of each of beneficiary 102 and originator 104, a customer reference number, and the geographic location of each party. Additional discretionary data can be contained with the funds verification message 128, such as information pertaining to the reason why the originator 104 is sending funds; address for the originator 104 or beneficiary 102; identification information for originator 104, such as country ID, passport number, etc; and additional data that can uniquely and correctly identify the originator 104 to the beneficiary 102.

The format of funds verification message 128 and funds verification response message 130 will allow information to be carried in such a way to provide the greatest amount of flexibility and variance in order to support as many exemplary embodiments of the application. Free form Tag Length Value fields are one example of how to accommodate these data elements. In some embodiments, standard's body and industry specific tags and lengths can be assigned and maintained, while in other embodiments the tags will be proprietary to the payment service network 108. Competitive payment networks are often unable to carry flexible and varied data elements because of the rigid structure of the messages processing through their payment network and because of the restrictive processing capabilities of the participants using the payment network. Some domestic clearinghouse solutions are unable to process varied and flexible data elements, thus limiting the number applications their network can support.

This expansive set of information that is transferred between Bank O 106 and Bank B 110 during a pre-settlement conversation allows for confirmation of the details regarding the transaction. Confirmation of such details reduces the chances for a faulty push transaction, exception items, cancelled transactions, and funds that are sent back to a Bank O 106. The information can also be reviewed to ensure that the transaction satisfies regulatory and legal compliance. Such review reduces that chances that a Bank O 106 or Bank B 110 will facilitate transactions that might violate some type of regulation or law. Such laws can be aimed to prevent money laundering or terrorist activities or funding activities such as drug sales; black markets; illegal gaming, just to name a few examples. The decision to refuse a transaction can be based upon the identity of the beneficiary 102, the country in which originator and/or beneficiary reside, the amount of funds that is being transferred, the reason for the transfer, the type of identification provided; the status of the beneficiary account, and the parameters established by the beneficiary 102 for receiving payments, just to name a few. In some situations, a maximum limit can be set for each transaction. The maximum amounts may vary according to certain situations. For example, in funds transfer transaction, the maximum amount may need to be $50,000.00 USD, yet for bill payment the maximum amount may be $500,000.00 USD. These maximum limits can be aimed at limiting the amount of risk associated with each application using the push payment infrastructure 100 and reduce the chances of funds laundering or other illegal types of activities.

As discussed, Bank B 110 evaluates the accuracy of the information contained within funds verification message 128. Bank B 110 also verifies that beneficiary 102 is registered and able to receive a pushed payment by reviewing a subset of PPRF 116. A pushed payment would not be receivable when a beneficiary's account is closed, invalid, or non-participating in the push payment system 100. The subset of PPRF 116 is the database maintained by Bank B 110 that shows the beneficiaries 102 that are able to receive pushed payment transactions and their corresponding accounts. Bank B 110 also authenticates the beneficiary 102 according to information contained in its customer account file 114.

In step 6, after the evaluation by Bank B 110, funds verification response message 130 is sent from Bank B 110 back to Bank O 106. Funds verification response message 130 is sent through the verification sub-system 120 of payment service network 108. Essentially, funds verification response message 130 is a message from Bank B 110 indicating that all is in readiness to receive the funds and that, yes, Bank O 106 should request that funds move from originator 104 to the beneficiary 102. In other words, once Bank O 106 has received the funds verification response message 130 (in the affirmative), both banks know that they may now proceed with the transaction. Of course, if the evaluation process of step 5 uncovers any discrepancies or potential regulatory violations, funds verification response message 130 will inform Bank O 106 that the push payment transaction has been declined.

Funds verification response message 130 can also indicate to Bank O 106 when the pushed funds will be made available. Such information can be indicated with separate and distinct response codes in funds verification response message 130 such that Bank O 106 knows when and how Bank B 110 intends to make funds available to the beneficiary's account. For example, funds can be posted to a beneficiary's account immediately, at the end of the business day, or at some other time.

In an alternative embodiment, payment service network 108, rather than Bank B 110, performs at least some of the evaluation of the accuracy and the regulatory and legal compliance of the push payment transaction. Verification subsystem 120 of payment service network 108 performs the evaluation based on criteria provided by Bank B 110 and provides the funds verification response message 130. The service performed by the payment service network 108 is referred to as an “on behalf of” service where payment service network 108 performs the evaluation on behalf of Bank B 110.

In some embodiments, the pre-settlement conversation is not necessary and therefore not performed. Pre-settlement conversations may not be necessary, for example, when the transactions involve recurring payments between two entities that have a pre-established relationship.

At step 7, Bank B 110 optionally sends a payment verification message 132 to beneficiary 102, indicating that beneficiary 102 will soon receive funds from originator 104. Similarly, Bank O 106 sends a payment acknowledgement message 134 to originator 104 indicating that funds have been taken from originator's account or will soon be taken. Both payment verification message 132 and payment acknowledgement message 134 may happen before funds are actually moved, during, or subsequent to the movement of funds. These messages may take the form of an electronic mail message, a text message to a mobile device, a written message, an oral message, a formal bank statement, etc.

The funds verification message 128, funds verification response message 130, payment verification message 132, and payment acknowledgement message 134 can be sent in real time or in non-real time. If sent in real time, beneficiary 102 and originator 104 can immediately be informed if the payment transaction will be successfully performed.

Performing the pre-settlement conversation is optional according to specific business applications. For example, in the instance of a recurring payment, it may not be necessary to perform a pre-settlement conversation before every settlement transaction. Alternatively it may be suggested that a pre-settlement conversation be performed before every funds transfer transaction.

At step 8, Bank O 106 is ready to settle accounts with Bank B 110 via payment service network 108. Settlement involves the payment service network 108 debiting Bank O 106 the desired amount of funds to be credited to the account of beneficiary 102. Settlement can occur immediately after the pre-settlement conversation or, if a pre-settlement conversation did not occur, then settlement could occur immediately after step 3 where Bank O 106 completes its authentication of originator 104. Alternatively, settlement can occur at some time after the pre-settlement conversation. For example, a single push payment transaction could be settled in real time or together with a batch of other transactions in a batch settlement process. Batch settlement can occur at various times throughout a day or week.

The settlement process begins at step 8 when a settlement message 132 is sent from Bank O 106 to payment service network 108. Settlement message 132 carries all of the information that will allow the Bank B 110 to clear and post funds to the correct and valid beneficiary account. In some embodiments, settlement message 132 also includes detailed remittance information that will describe what the payment is for. Such information is important for all but the smallest beneficiaries 102 to correctly account for payments made against balances owed.

Settlement message 132 also includes the amounts to be transferred to Bank B 110. Funds may be moved in any suitable fashion according to payment service network 108. For example, funds can be transferred through a bank wire or through a domestic clearinghouse or via a domestic Central Bank settlement.

At step 9, settlement subsystem 122 receives settlement message 132 within payment service network 108. Settlement subsystem 122 processes the settlement message 132 and the funds to be transferred. The settlement subsystem 122 creates the net debit and credit positions for each participant bank so designated with the Master PPRF 118. From these debit or credit positions, wire transfers take place and funds are moved. All of the fields, tables, files, and edits that define services and parameters per bank are contained within the settlement subsystem 122. Settlement subsystem 122 is also able to process, edit and act upon the data contained within the fields of settlement message 132. Similar to the verification subsystem 120 and funds verification message 128, settlement message 132 will contain such information pertaining to the reason why the originator 104 is sending funds; address for the originator 104 or beneficiary 102; identification information for originator 104, such as country ID, passport number, etc; and additional data that can uniquely and correctly identify originator 104 to beneficiary 102. Settlement message 132 may also include information about the push payment transaction such as the beneficiary indicator, the amount to push to beneficiary 102, an indicator as to if the transaction is for bill payment, a purchase transaction, or for funds transfer, etc., an invoice number, posting technique and timing, account numbers of each of beneficiary 102 and originator 104, a customer reference number, and the geographic location of each party. Additionally the settlement subsystem 122 can also decline any requests to debit funds from the account of beneficiary 102 if the beneficiary account is defined as a deposit only account.

In most implementations of the push payment system 100, good funds are assumed, which means that the payment service network 108 assures that Bank O 106 will successfully transfer funds to Bank B 110.

Settlement message 132 is forwarded to the appropriate Bank B 110 by payment service network 108. At step 10, Bank B 110 posts the payment to the designated beneficiary account and provides beneficiary 102 with appropriate notification of payment and the necessary remittance information. Alternatively, such notification can occur at an earlier or a later time in the payment process.

At step 11, beneficiary 102 has the option to send a bill of sale 134 to originator 104 in order to acknowledge that the funds have been received and any obligation on the part of originator 104 has been satisfied. For example, bill of sale 134 may function as a release obligation for exchanged goods.

### Reversals and Sendbacks

Sometimes a “reversal” or cancellation of a pre-settlement conversation or settlement process is required. A reversal may be required when a duplicate pre-settlement conversation or settlement processes is erroneously initiated. The pre-settlement transaction, and therefore the payment transaction, can be cancelled during the pre-settlement conversation by originator 104 or Bank O 106. For example, the payment transaction can be cancelled during any of steps 4-7. The settlement process may be cancelled by a reversal message sent from Bank O 106 to Bank B 110.

In one embodiment, there is a “send back” option associated with settlement message 132. The send back option gives Bank B 110 the option to send back settlement message 132 (along with the funds) if these funds cannot be appropriately delivered to the beneficiary's account, if the funds were received in error, a duplicate settlement message 132 was erroneously transmitted, or for any other reason established by the payment service network 108 and agreed to by the participants.

In step 12, when funds actually cannot be posted to a beneficiary's account, settlement sendback message 136 is sent from Bank B 110 to Bank O 106 to give notification of the inability to post funds to the beneficiary's account and to return the funds to Bank O 106. The funds are also sent back to Bank O 106. In some embodiments “reason codes” can be included within the settlement sendback message 136 so that the Bank O 106 can inform originator 104 why funds did not post to the beneficiary account. Exemplary reasons that would require sending funds back to Bank O 106 include: a beneficiary's account becomes invalid or closed between the time of the pre-settlement conversation and the settlement process, receiving instructions from a third party such as a government agency to cancel the transaction, a delinquent account, an account is not participating in push payment system 100, beneficiary account in arrears, duplicate processing, etc.

In some embodiments, a sendback transaction (i.e., returning funds to a Bank O 106) may be reversed or cancelled by a reversal message sent by Bank B 110 to Bank O 106. A send back transaction may require reversal when, for example, a duplicate sendback transaction is sent from Bank B 110 to Bank O 106. Reversal of a sendback transaction also involves the crediting of a beneficiary's account at Bank B 110 and the debiting of an originator's account at Bank O 106.

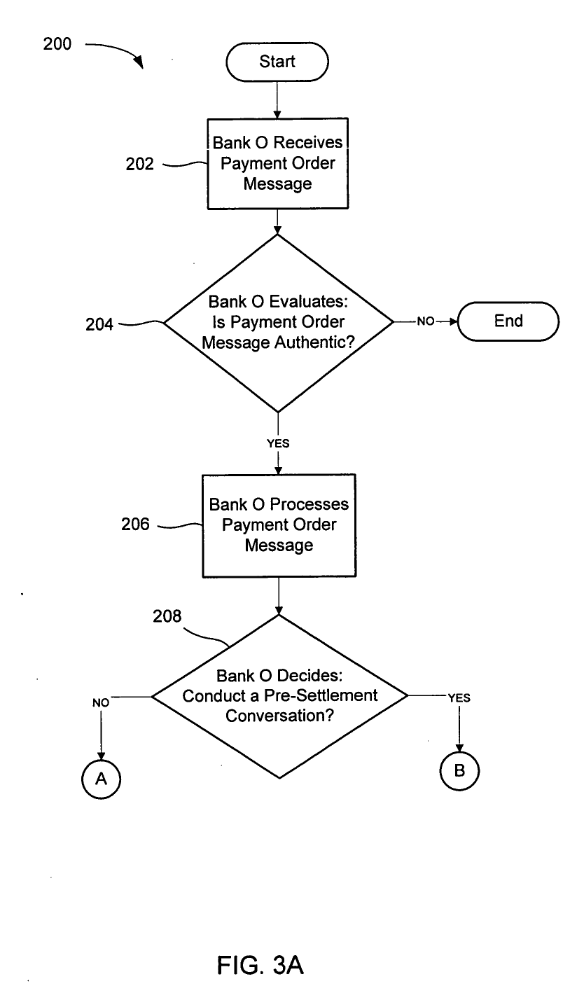

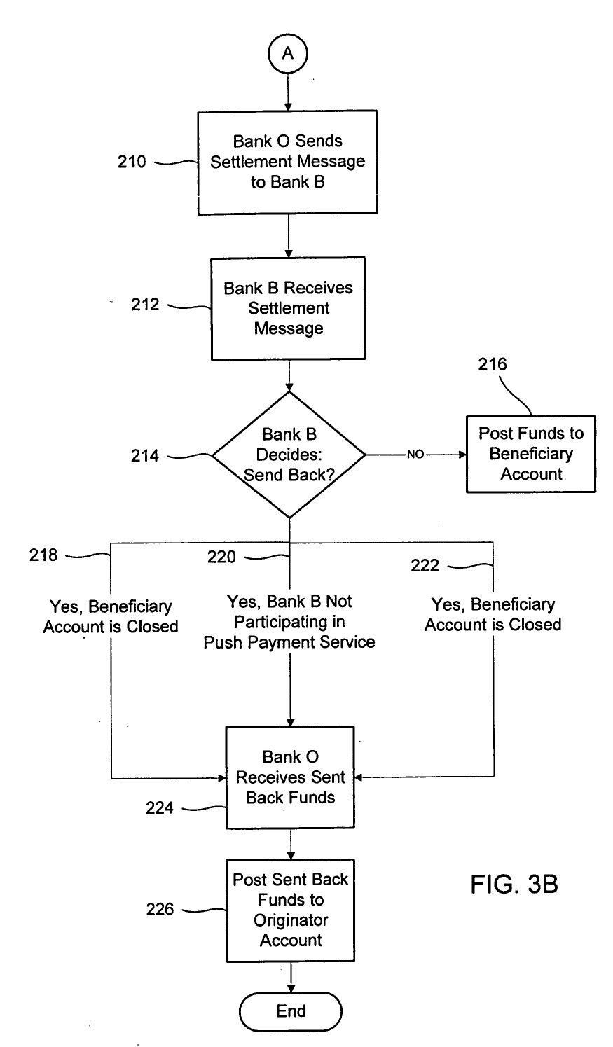

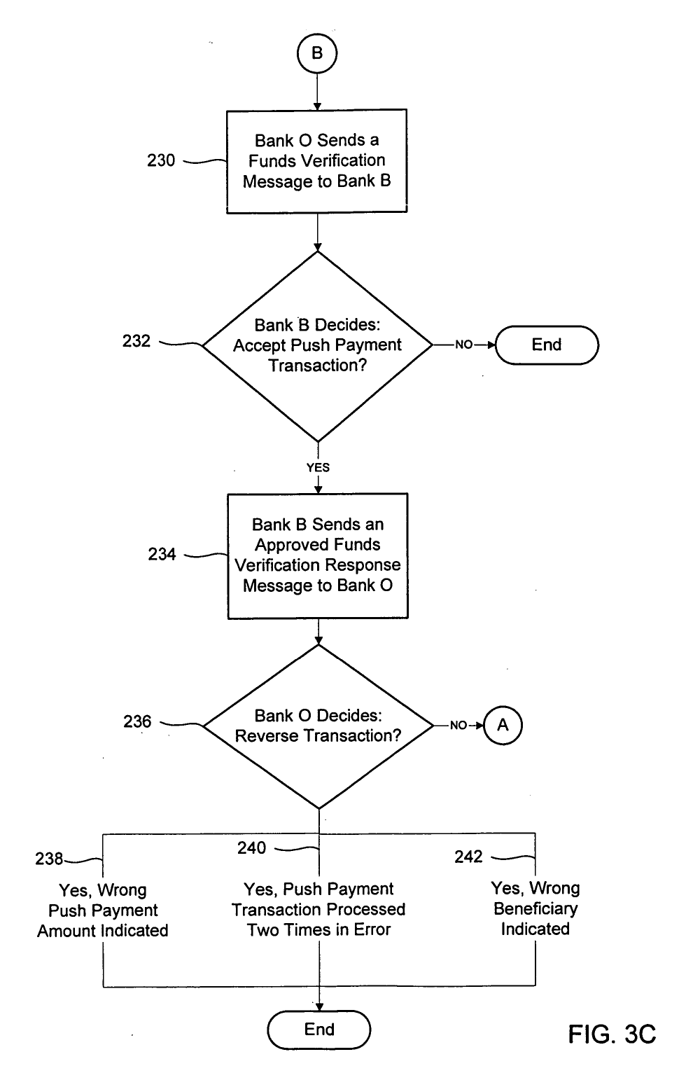

FIGS. 3A-3C illustrate a flow diagram that describes the push payment process 200 and the reversal and sendback options according to an alternative embodiment of the present invention. Some of the same reference numbers used in FIG. 1 are used in describing FIGS. 3A-3C. The push payment process 200 begins at block 202 where Bank O 106 receives a payment order message 126 from a payment originator 104. This step is analogous to step 2 of FIG. 1.

At decision block 204, Bank O 106 determines whether the payment order message is authentic. At this step, Bank O 106 can also perform a test to determine the authenticity of the originator's identity. If the payment order message is not authentic or if the identity of the originator's identity is not authentic, then the push payment process ends. If the payment order message 126 is authentic, then the process flow into block 206. In some embodiments, the identity of the originator 104 is verified to be authentic before the process 200 continues onto block 206. This step is analogous to step 3 of FIG. 1.

At decision block 206, Bank O 106 processes the payment order message 126. Then at decision block 208, Bank O 106 determines if a pre-settlement conversation will be conducted for a particular push payment transaction. This decision can be based upon attributes of a particular originator 104 and/or practices of Bank O 106 and Bank B 110. If Bank O 106 decides to proceed with the push payment process without a pre-settlement conversation, then the process 200 continues along path A, which is further described in FIG. 3B. If Bank O 106 decides that a pre-settlement conversation is required, then the process 200 continues along path B, which is further described in FIG. 3C.

Referring to FIG. 3B when no pre-settlement conversation is performed, the process flows into block 210 where Bank O 106 sends a settlement message 132 to Bank B 110. The settlement message 132 is sent through settlement subsystem 122 and payment service network 108. Settlement message 132 has a sendback option that will allow Bank B 110 to send back the settlement funds if it is later deemed necessary. This step is analogous to step 4 of FIG. 1.

Once the settlement message has been sent, it is entirely possible that Bank O might decide to reverse the settlement transaction. Bank O might decide to reverse the transaction because the wrong push payment amount was indicated, the push payment transaction was processed two times in error, or because the wrong beneficiary was indicated. If the settlement transaction were reversed, Bank B would eventually receive a settlement reversal message. A technique for performing such a settlement reversal may be performed in a similar manner as for a transaction reversal.

Assuming that there is no settlement reversal, at block 212 Bank B 110 receives the settlement message 132. Then at decision block 214, Bank B 110 determines if the settlement funds need to be “sentback” to the beneficiary and Bank O 106. This step is performed during step 10 of FIG. 1. If the settlement funds do not need to be sent back, then the funds are posted to the beneficiary's account in block 216. However, if the settlement funds need to be sentback to Bank O 106, then block 224 represents the step where Bank B 110 sends back the funds to Bank O 106 and Bank O 106 receives the “sentback” funds. Block 224 is analogous to step 12 of FIG. 1.

FIG. 3B shows three paths 218, 220, and 222 (or situations) where the settlement funds are “sentback” to Bank O 106. Path 218 represents the situation where a beneficiary's account is invalid. Path 220 represents the situation where Bank B 110 is not participating in the push payment service. And path 222 represents the situation where the beneficiary's account is closed. In each situation, the funds cannot be posted to the beneficiary's account and therefore need to be sent back to Bank O 106.

Block 226 represents the step of posting the “sentback” funds back into the originator's account. Then at this point, the push payment transaction has come to an end.

Now, referring to FIG. 3C when a pre-settlement conversation is required, the process flows from decision block 208 to block 230. At block 230, Bank O 106 sends a funds verification message 128 to Bank B 110. The funds verification message 128 initiates the pre-settlement conversation. Funds verification message 128 contains an array of information about the participants and the push payment transaction that will allow Bank B to evaluate the push payment transaction. This step is analogous to step 4 of FIG. 1.

At decision block 232, Bank B 110 evaluates the information contained in the funds verification message 128 to determine whether to accept the push payment transaction. Bank B 110 may decide to decline the push payment transaction for various reasons discussed above. For example, Bank B 110 can decline any transactions involving funds above a certain value or transactions originating from a certain geographical area. If Bank B 110 decides to decline the transaction, process 200 terminates.

If Bank B 110 accepts the push payment transaction at decision block 232, then the process flow continues onto block 234. At block 234, Bank B 110 sends an approved funds verification response message 130 to Bank O 106. The approved funds verification response message 130 indicates to Bank O 106 that Bank B 110 will accept the push payment transaction. Block 234 is analogous to step 6 of FIG. 1.

At decision block 236, Bank O 106 decides whether to reverse (cancel) the push payment transaction. At this time, Bank O 106 can take the opportunity to reverse the transaction if it discovers any problems. For example, paths 238, 240, and 242 represent three situations where Bank O 106 can decide to reverse the transaction even though Bank B 110 is ready to proceed. Path 238 represents the situation where an originator or Bank O 106 has indicated an incorrect amount to be pushed to Bank B 110. Path 240 represents the situation where a push payment transaction has been processed multiple times, in error. Therefore, the second and duplicative transaction should be reversed. Path 242 represents the situation where an originator or Bank O 106 indicated an incorrect beneficiary to receive the pushed funds. In each situation, Bank O 106 decides to reverse the transaction. As a result, the push payment transaction comes to an end.

On the other hand, if Bank B 110 decides to proceed with the transaction at decision block 236, the process 200 continues through path A. Path A leads to the process flow in FIG. 3B where the settlement process occurs. The push payment transaction then follows through the flow as was described above for FIG. 3B.

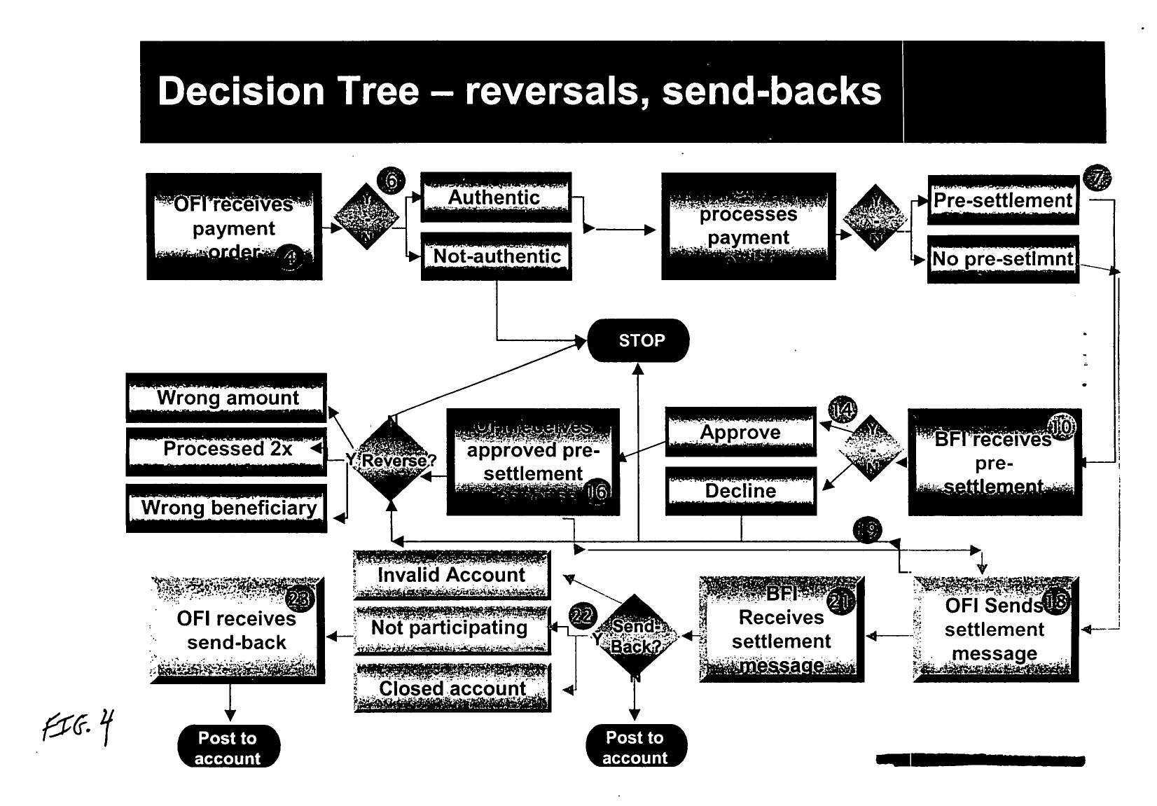

FIG. 4 is a decision tree showing another view of how reversals and sendbacks are performed.

### Alternative Embodiments

As discussed earlier, the push payment transaction of the present invention can handle domestic and international transactions. Push payment system 100 can include a currency conversion process for international transactions where an originator 104 can select the type of currency to be deposited into the beneficiary's account. Originator 104 can select the amount of funds to be pushed and designate the currency type for either the amount to be withdrawn from the originator's account or the amount to be pushed into the beneficiary's account. Originator 104 can identify the funds amount and the currency type in payment order message 126. Payment order message 126 can also specify the country and/or address of each of originator 104 and beneficiary 102.

Then payment service network 108 can use its conversion rates and process to convert the funds to the selected currency. In an alternative embodiment, Bank O 106 can perform the currency conversion.

Originator 104 can select the amount of money to be pushed in the currency of either the local currency relative to originator 104 or the billing or foreign currency of beneficiary 102.

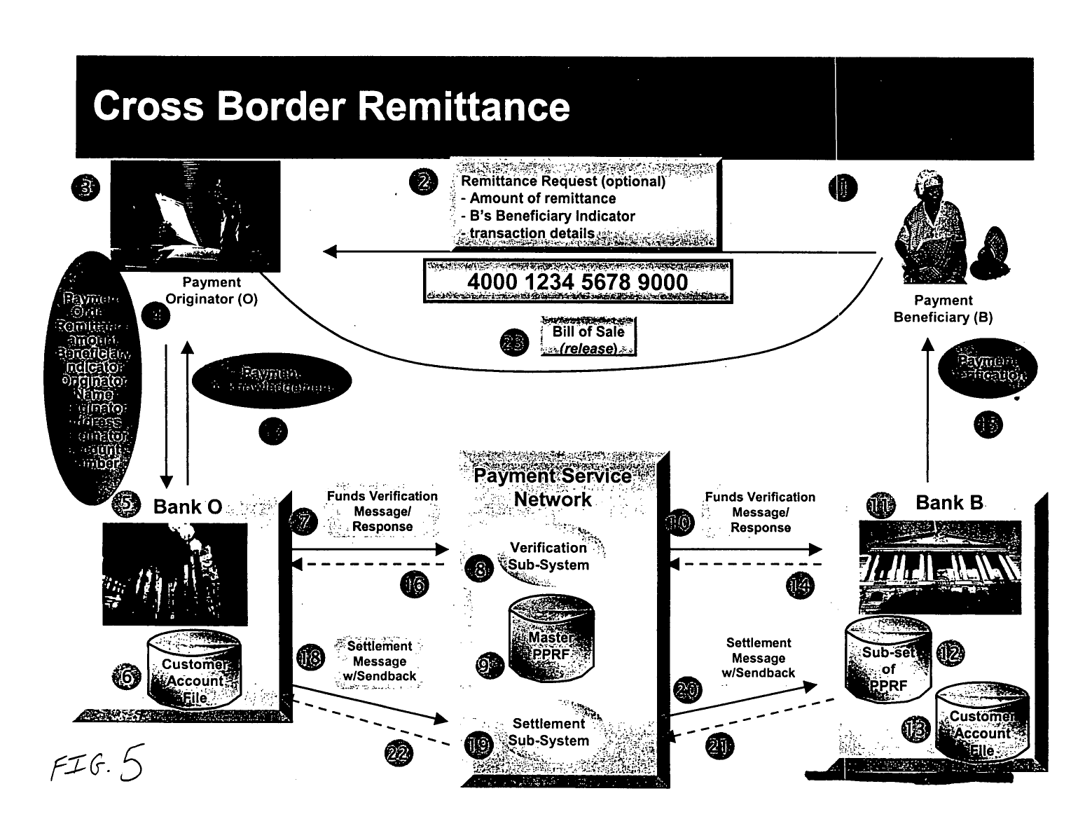

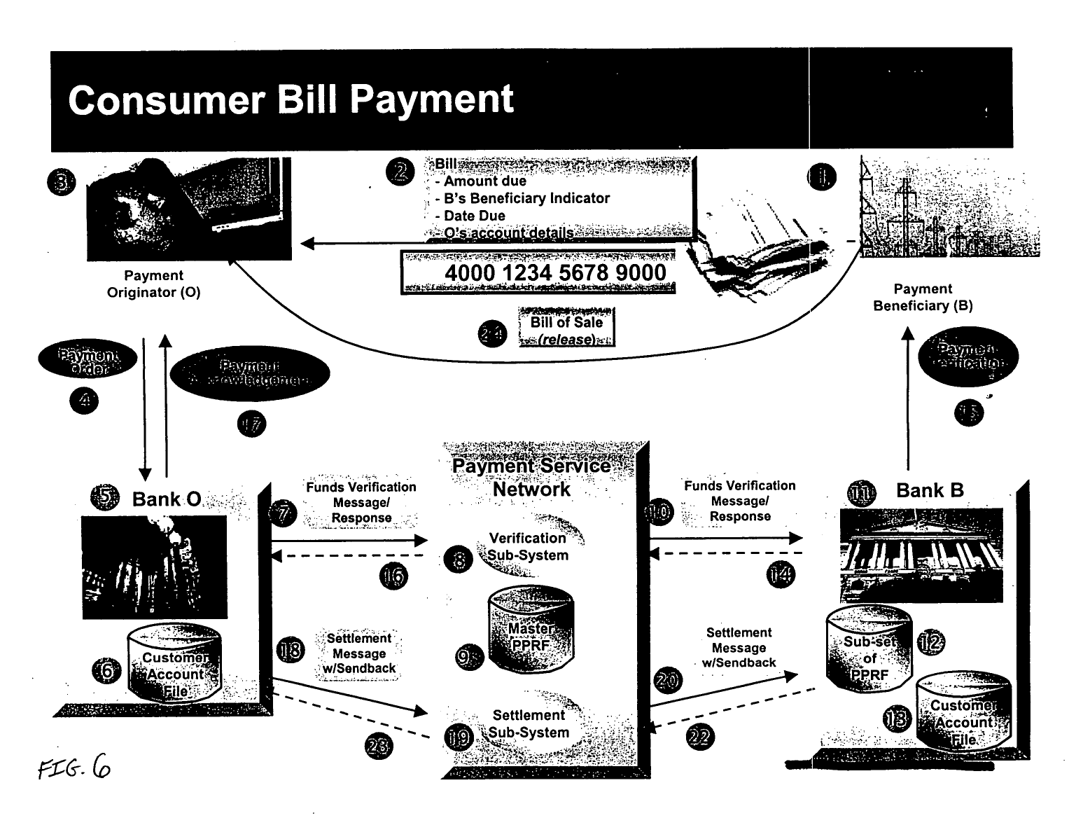

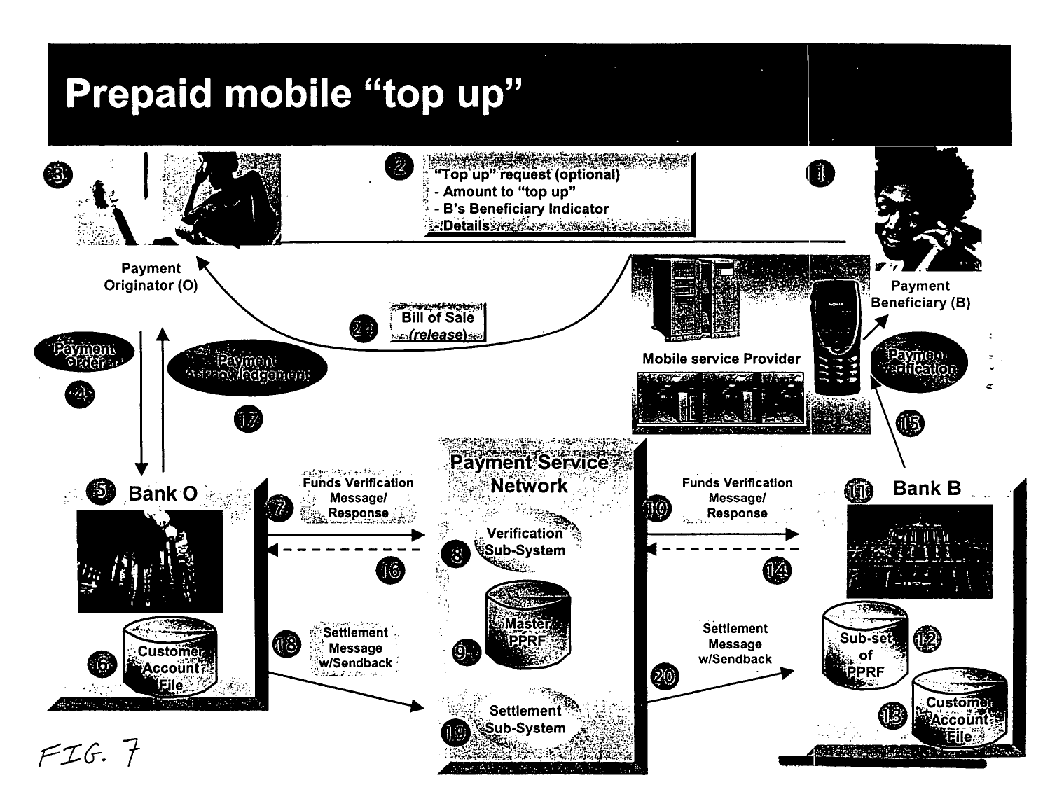

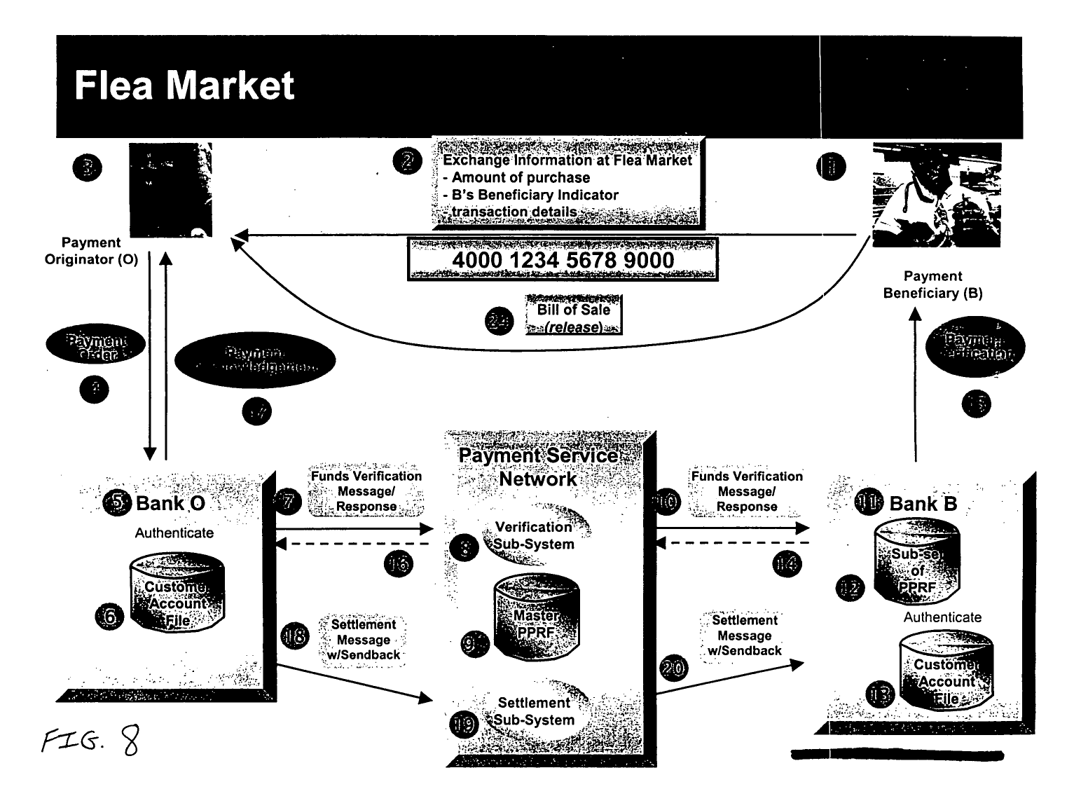

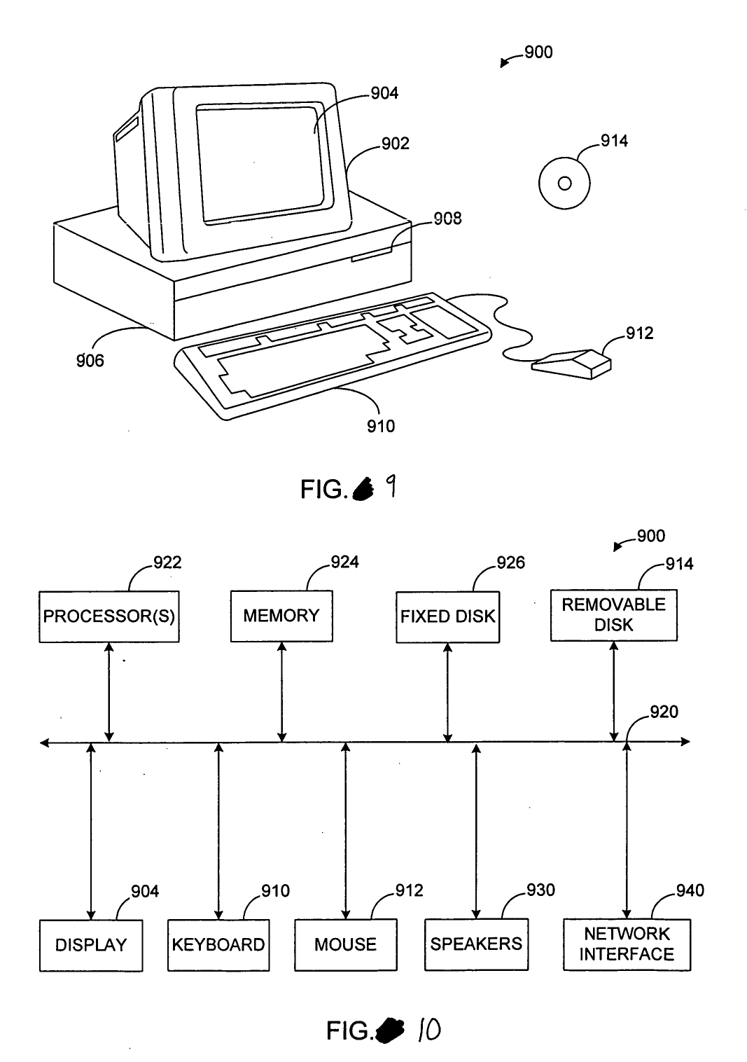

The present invention is also suitable for implementation in a wide variety of real-world situations. For example, FIG. 5 shows an embodiment for cross-border remittance by which an individual in one country can push funds to an individual in another country, such as a gift from one relative to another. FIG. 6 shows an embodiment for consumer bill payment in which a consumer pushes funds to a billing entity. FIG. 7 shows an embodiment for topping up (i.e., topping off) a mobile telephone by which one individual can push funds to another individual's prepaid mobile telephone account. FIG. 8 shows an embodiment for a person-to-person payment, such as between two individuals who have arranged a transaction at a flea market.

### Computer System

FIGS. 9 and 10 illustrate a computer system 900 suitable for implementing embodiments of the present invention. FIG. 9 shows one possible physical form of the computer system. Of course, the computer system may have many physical forms ranging from an integrated circuit, a printed circuit board and a small handheld device up to a huge super computer. Computer system 900 includes a monitor 902, a display 904, a housing 906, a disk drive 908, a keyboard 910 and a mouse 912. Disk 914 is a computer-readable medium used to transfer data to and from computer system 900.

FIG. 10 is an example of a block diagram for computer system 900. Attached to system bus 920 are a wide variety of subsystems. Processor(s) 922 (also referred to as central processing units, or CPUs) are coupled to storage devices including memory 924. Memory 924 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 926 is also coupled bi-directionally to CPU 922; it provides additional data storage capacity and may also include any of the computer-readable media described below. Fixed disk 926 may be used to store programs, data and the like and is typically a secondary storage medium (such as a hard disk) that is slower than primary storage. It will be appreciated that the information retained within fixed disk 926, may, in appropriate cases, be incorporated in standard fashion as virtual memory in memory 924. Removable disk 914 may take the form of any of the computer-readable media described below.

CPU 922 is also coupled to a variety of input/output devices such as display 904, keyboard 910, mouse 912 and speakers 930. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 922 optionally may be coupled to another computer or telecommunications network using network interface 940. With such a network interface, it is contemplated that the CPU might receive information from the network, or might output information to the network in the course of performing the above-described method steps. Furthermore, method embodiments of the present invention may execute solely upon CPU 922 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

While this invention has been described in terms of several preferred embodiments, there are alteration, permutations, and equivalents, which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

1. A method for an originator to transfer funds to a beneficiary comprising:
holding a pre-settlement conversation between said originator and a beneficiary bank regarding said transfer of funds;
sending a payment message by said originator to an originator bank, said payment message requesting said originator bank to push said funds to said beneficiary bank;
indicating a beneficiary indicator in said payment message, said beneficiary indicator indicating a beneficiary account that will be credited with said funds, said beneficiary account being maintained by said beneficiary bank; and
pushing said funds from said originator bank to said beneficiary bank wherein said beneficiary account is credited with said funds.

2. A method as recited in claim 1 wherein said pre-settlement conversation is held over a payment service network.

3. A method as recited in claim 1 wherein said beneficiary indicator is publicly known.

4. A method as recited in claim 1 wherein said beneficiary indicator is a routing number and only requests credits to said beneficiary account.

5. A method as recited in claim 1 wherein said beneficiary indicator is a name assigned to said beneficiary, said method further comprising:
referencing a name-to-beneficiary account conversion table to identify said beneficiary account, which corresponds to said assigned name, out of a plurality of beneficiary accounts.

6. A method as recited in claim 1 wherein said beneficiary indicator is a credit or debit card number.

7. A method as recited in claim 1 further comprising:
sending a payment verification message to said beneficiary in order to inform said beneficiary that said beneficiary account will be credited with said funds.

8. A method as recited in claim 7 further comprising:
providing a digital token to said originator in exchange for said funds;
unlocking digital content, by said originator, with said digital token;
accessing said digital content by said originator.

9. A method as recited in claim 7 further comprising:
crediting a service account of said originator in exchange for said funds, said service account being provided and maintained by said beneficiary.

10. A method as recited in claim 1 further comprising:
registering said originator bank with a payment service network to allow customers of said originator bank to push said funds from said originator bank to said beneficiary bank; and
registering said beneficiary bank with said payment service network to allow customers of said beneficiary bank to receive said funds at said beneficiary bank.

11. A method as recited in claim 10 further comprising:
registering said originator with said originator bank to allow said originator to push said funds from said originator bank to said beneficiary bank; and
registering said beneficiary with said beneficiary bank to allow said beneficiary to receive said funds at said beneficiary bank.

12. A method as recited in claim 1 further comprising:
facilitating said pre-settlement conversation over a clearing and settlement payment service network.

13. A method for an originator to transfer funds to a beneficiary comprising:
sending a funds verification message from an originator bank to a beneficiary bank, said funds verification message informing said beneficiary bank of said funds to be transferred to said beneficiary bank;
sending a funds verification response message from said beneficiary bank to said originator bank, said funds verification response message serving to authorize or decline said transfer of said funds to said beneficiary bank; and
pushing said funds from an originator account maintained by said originator bank into a beneficiary account maintained by said beneficiary bank if said funds verification response message authorizes said transfer of said funds.

14. A method as recited in claim 13 further comprising:
providing a payment service network that at least provides a communication pathway between said beneficiary bank and said originator bank, wherein each of said sending operations relays each of said funds verification and funds verification response message via said payment service network.

15. A method as recited in claim 14 wherein said sending of said funds verification response message is sent by said payment service network, said method further comprising:
deciding, by said payment service network, to authorize or decline said transfer of said funds.

16. A method as recited in claim 13 further comprising:
including information within said funds verification message that relates to said transfer of said funds.

17. A method as recited in claim 16 further comprising:
evaluating said information within said funds verification message; and
deciding to authorize or decline said transfer of said funds based upon said information.

18. A method as recited in claim 16 further comprising:
verifying by said beneficiary bank that said beneficiary account is valid and able to accept said pushed funds.

19. A method as recited in claim 14 further comprising:
converting, by said payment service network, said funds to be transferred to a different type of currency as requested by said originator.

20. A method as recited in claim 13 wherein the funds verification message and said funds verification response message are sent in real time.

21. A method as recited in claim 20 wherein the funds verification message and said funds verification response message are sent online.

22. A method as recited in claim 13 wherein said funds is pushed into said beneficiary account immediately after said funds verification response message is sent to said originator bank.

23. A method as recited in claim 13 further comprising:
sending said funds verification message and funds verification response message over a clearing and settlement payment service network.

24. A payment system comprising:
an originator and a beneficiary wherein said originator intends to transfer funds to said beneficiary;
an originator bank that maintains an originator account;
a beneficiary bank that maintains a beneficiary account;
a funds verification message that is sent from said originator bank to said beneficiary bank, said funds verification message informing said beneficiary bank of said funds to be transferred to said beneficiary bank; and
a funds verification response message that is sent to said originator bank, said funds verification response message serving to authorize or decline said transfer of funds to said beneficiary bank, wherein said funds verification message and said funds verification response message are sent before settlement of the transfer of funds.

25. A system as recited in claim 24 wherein said funds verification message further includes information relating to the identity of said originator and said beneficiary, or to the purpose of said transfer of funds.

26. A system as recited in claim 24 wherein said funds verification message further includes geographic location information for said beneficiary or for said originator.

27. A system as recited in claim 24 wherein said funds verification message further includes information that indicates whether the transfer of funds is for a purchase transaction or is a funds transfer.

28. A system as recited in claim 24 further comprising:
a payment service network that at least provides a communication pathway between said beneficiary bank and said originator bank, wherein said funds verification and funds verification response message are sent via said payment service network.

29. A system as recited in claim 28 wherein said payment service network is configured to review said funds verification message, determine whether to authorize or decline said transfer of funds, and generate said funds verification response message.

30. A system as recited in claim 28 wherein said beneficiary bank is configured to review said funds verification message, determine whether to authorize or decline said transfer of funds, and generate said funds verification response message.

31. A system as recited in claim 28 wherein said payment service network also provides for communication for clearing and settlement of said transfer of funds.

32. A system as recited in claim 28 further comprising:
a payment participant reference file (PPRF) maintained by the payment service network, said PPRF containing information relating to said originator bank and said beneficiary bank.

33. A system as recited in claim 39 further comprising:
a beneficiary indicator that identifies an account of said beneficiary, wherein said originator uses said beneficiary indicator to transfer said funds to said beneficiary.
